(19) United States
(12) Patent Application Publication
(10) Pub. No.: US 2012/0127872 A1
(43) Pub. Date: May 24, 2012

(54) SCALABLE VIDEO MULTICAST METHOD IN WiMAX NETWORKS

(76) Inventor: Jang Ping SHEU, Hsinchu City (TW)

(21) Appl. No.: 13/104,717

(22) Filed: May 10, 2011

(30) Foreign Application Priority Data
Nov. 24, 2010 (TW) 099145785

(51) Int. Cl. H04W 4/06; H04W 24/00

(52) U.S. Cl. 370/252; 370/312

(57) ABSTRACT

A scalable video multicast method in WiMAX networks is provided in the embodiments of the present invention. The method arranges data transmitting mechanisms and data transmitting rates for a base station and at least a relay station according to network productivity of each bandwidth unit to satisfy the demands of subscriber stations so as to maximize the network productivity within a limited bandwidth.

This application claims the benefit of the filing date of Taiwan Application Ser. No. 099145785, filed on Nov. 24, 2010, the content of which is incorporated herein by reference.

### BACKGROUND OF THE INVENTION

(a) Field of the Invention

The invention relates to a video broadcast method, particularly to a scalable video multicast method in WiMAX networks.

(b) Description of the Related Art

WiMAX (Worldwide Interoperability for Microwave Access) is authored in IEEE 802.16j standard by IEEE. In order to provide a convenient and popular communication service with high cost effectiveness, the WiMAX system is increased its network functionality and productivity by constructing relay stations in IEEE 802.16e network. Therefore the WiMAX relay network may effectively provide a video multicast application platform.

However, the design of prior video multicast mechanisms in IEEE 802.16e network does not consider influences of signal inference generated by the relay stations in the network. As a result, influences of signal inference may decrease network efficiency of the video multicast mechanisms. Due to the development of video coding technology (H.264\SVC), it makes the video multicast mechanisms provide various kinds of data transmission rate services to replace the prior data transmission rate service with single data transmission rate. Therefore the current video multicast mechanisms may use more bandwidth to conform to different transmission rate. Since the network bandwidth is limited, the usage efficiency of the network bandwidth of the video multicast mechanisms becomes lower.

### BRIEF SUMMARY OF THE INVENTION

One object of the invention is to provide a modulation mechanism of data transmission rate arrangement in a relay network to maximize the network productivity within a limited bandwidth.

One embodiment of the invention provides a scalable video multicast method. In WiMAX network, each relay station and each subscriber station has its required data transmission rate. The scalable video multicast method refers to the required data transmission rates of the stations to estimate network productivity of each unit within a bandwidth. Further the scalable video multicast method arranges data transmission rate according to an estimation result to maximize the network productivity within a limited bandwidth.

One embodiment of the invention provides a scalable video multicast method in WiMAX networks, where the WiMAX network provides a base station, a plurality of relay stations, and a plurality of subscriber stations and there is a relay station between at least one of the subscriber stations and the base station. It should be noted that the subscriber station may be coupled to the base station directly or coupled to the base station through the relay station. The scalable video multicast method includes the following steps: detecting a state of a subscriber station and a state of the relay station coupled with the subscriber station to determine a weight of the subscriber station; arranging the priority of the subscriber stations for service according to the weights of broadcast paths of the subscriber stations; assigning both a data modulation mechanism and a data transmission rate to a base station and each relay station according to the priority to generate a multicast table; and executing network video multicast according to the multicast table.

Furthermore, another embodiment of the invention provides a scalable video multicast method in WiMAX networks, where there is a relay station between at least one of the subscriber stations and a base station in the WiMAX network. The method includes the following steps:

acquiring a weight according to a data transmission rate of the subscriber station and channel qualities among the base station, the relay station and the subscriber station;

arranging the priority of the subscriber stations for service according to the weights of broadcast paths of the subscriber stations and assigning both a data modulation mechanism and a data transmission rate to a base station and each relay station to generate a multicast table; and executing network video multicast according to the multicast table.

Furthermore, another embodiment of the invention provides a scalable video multicast system in WiMAX networks. The system includes a base station, a plurality of relay stations, a plurality of subscriber stations and a plurality of subscriber stations. It should be noted that the subscriber station may be coupled to the base station directly or coupled to the base station through the relay station. The base station is used to provide a video broadcast service. The relay station provides first channel quality between the relay station and the base station, wherein each relay station is set between at least one of the subscriber stations and the base station. The subscriber station provides a data transmission rate required by the subscriber station and second channel quality between the subscriber station and the relay station. The base station acquires a first ratio according to the ratio of the data transmitting rate of the subscriber station to the first channel quality, acquires a second ratio according to the ratio of the data transmitting rate of the subscriber station to the second channel quality, acquires a bandwidth according to the first ratio and the second ratio, and acquires a weight according to the data transmitting rate of the subscriber station and the bandwidth. The priority of the subscriber stations is arranged for service according to the weights of broadcast paths of the subscriber stations. Data modulation mechanism and data transmission rate are assigned to a base station and each relay station according to the priority to generate a multicast table. Network video multicast is executed according to the multicast table.

The scalable video multicast system and method in WiMAX networks determine how much network productivity a subscriber station may be acquired for service in a unit of bandwidth, then assign a weight to each subscriber station, and utilize the weights to arrange the priority of the subscriber stations so as to assign an appropriate bandwidth for each subscriber station. Thus, the bandwidth can be effectively utilized to reduce the unnecessary bandwidth for data transmission rate to achieve the purpose of effectively servicing more users within a limited bandwidth.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a schematic diagram illustrating a scalable video multicast system in WiMAX networks according to one embodiment of the invention.

FIG. 2 shows a schematic diagram illustrating a scalable video multicast method in WiMAX networks according to one embodiment of the invention.

FIG. 3 shows a schematic diagram illustrating an example of assigning weights and arranging the priority of the scalable video multicast method in WiMAX networks according to one embodiment of the invention.

FIG. 4 shows a schematic diagram illustrating an example of arranging the multicast table of the scalable video multicast method in WiMAX networks according to one embodiment of the invention.

### DETAILED DESCRIPTION OF THE INVENTION

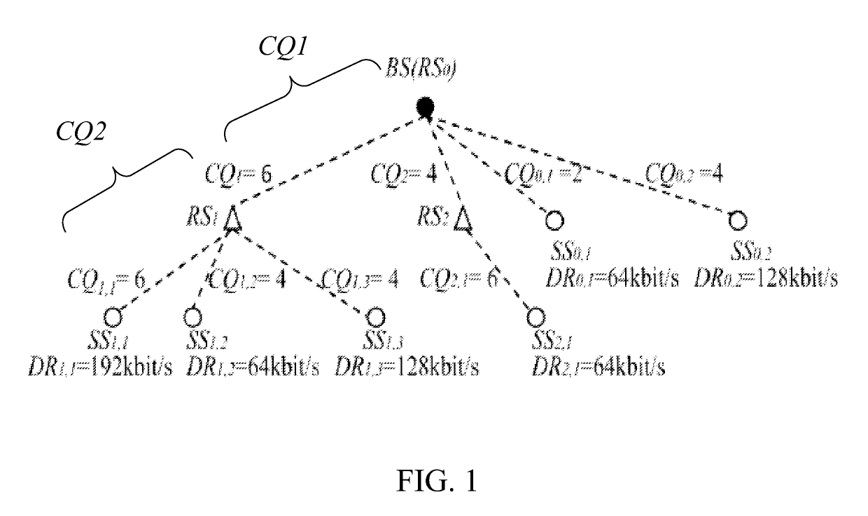

FIG. 1 shows a schematic diagram illustrating a scalable video multicast system in WiMAX networks according to one embodiment of the invention. The system includes at least one base station BS, a plurality of relay stations RS, and a plurality of subscriber stations SS. In an embodiment, there is a relay station RS between at least a subscriber station SS and a base station BS. It should be noted that the subscriber station SS may be coupled to the base station BS or coupled to the base station BS through the relay station RS.

The base station BS provides a video broadcast service. In one embodiment, a base station BS may be a relay station RS. The relay station RS provides data to the base station BS, where the data may be a first channel quality CQ1 between the relay station RS and the base station BS. The subscriber station SS provides data to the base station BS, where the data may be a data transmission rate DR required by the subscriber station SS and a second channel quality CQ2 between the subscriber station SS and the relay station RS.

Further the base station BS acquires a weight for each broadcast path according to the data transmission rate DR of the subscriber station SS, the first channel quality CQ1 and the second channel quality CQ2. The scalable video multicast system arranges the priority of the subscriber station SS according to the weight of broadcast paths of the subscriber stations SS. Further the scalable video multicast system assigns both a data modulation and a data transmission rate to the base station BS and the relay stations RS. Then the scalable video multicast system generates a multicast table according to this assignment and executes network video multicast broadcasting according to the multicast table.

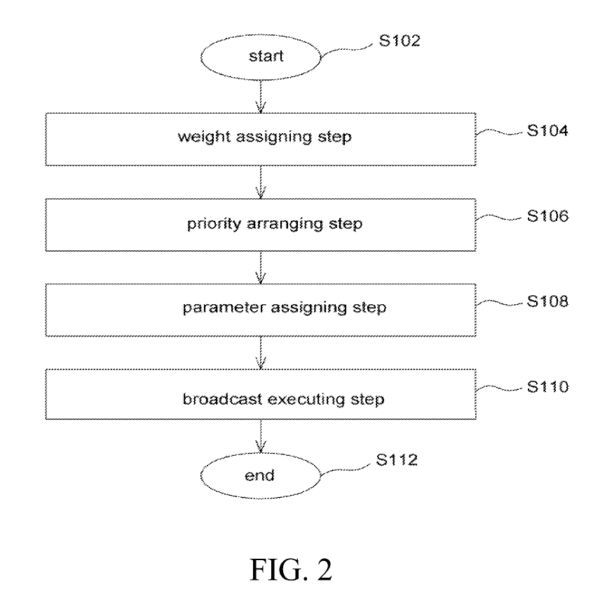

Please refer to FIGS. 1 and 2. As an example in FIG. 1, the scalable video multicast system includes a base station BS, a plurality of relay stations RS and a plurality of subscriber stations SS, where there is a relay station RS between at least one subscriber station SS and a base station BS. FIG. 2 shows a schematic diagram illustrating a scalable video multicast method in WiMAX networks according to one embodiment of the invention.

The method comprises the following steps:

Step S102: start.

Step S104: a weight assigning step, for detecting a subscriber station SS, a state of the relay station RS coupled with the subscriber station SS, a data transmitting rate DR required by the subscriber stations SS, first channel quality CQ1 between the base station BS and the relay station RS, and second channel quality CQ2 between the relay station RS and the subscriber station SS. Then, a first ratio R1 is acquired according to the ratio of the data transmitting rate DR of the subscriber station SS to the first channel quality CQ1 and a second ratio R2 is acquired according to the ratio of the data transmitting rate DR of the subscriber station SS to the second channel quality CQ2. A bandwidth B is acquired according to the first ratio R1 and the second ratio R2, and a weight W is acquired according to the data transmitting rate DR of the subscriber station SS and the bandwidth B.

Please refer to FIG. 1. It is assumed that the network is a WiMAX (Worldwide Interoperability for Microwave Access) relay network. There is a node between the subscriber station SS and the base station BS, and the node is a relay station RS. Further, as shown in FIG. 1, where RS, represents the i^{th} relay station RS (base station is the 0^{th} relay station), SS_{m,n} represents the n^{th} subscriber station SS coupling to the m^{th} relay station, DR_{m,n} represents the data transmission rate DR required by the subscriber station SS_{m,n}, CQₘ represents the first channel quality CQ1 between RSₘ and the base station BS, and CQ_{m,n} represents the second channel quality CQ2 between SS_{m,n} and RSₘ.

In one embodiment, the video multicast method of the invention calculates the bandwidth B required for the subscriber station SS_{m,n} by the following equation:

B_{m,n}=DR_{m,n}/CQₘ+DR_{m,n}/CQ_{m,n} (1)

where DR_{m,n}/CQₘ represents the bandwidth required between the base station BS and the relay station RS and DR_{m,n}/CQ_{m,n} represents the bandwidth required between the relay station RS and the subscriber station SS. According to the above method, an assigned weight W of each subscriber station SS is DR_{m,n}/B_{m,n}.

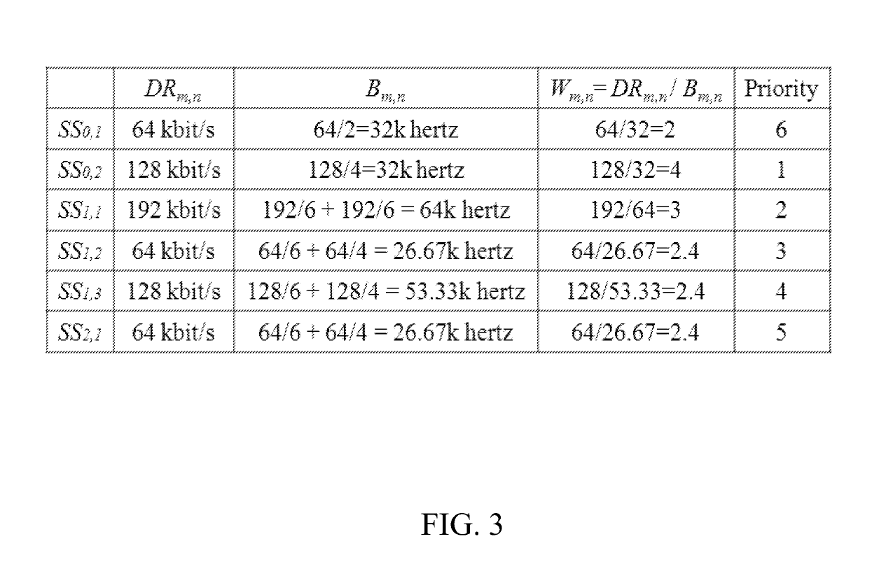

Step S106: a priority arranging step, for arranging the priority of the subscriber stations for service according to the weights of broadcast paths of the subscriber stations. As shown in FIG. 3, an example of assigning a weight for each subscriber station and arranging the priority in the video multicast system is illustrated.

Step S108: a parameter assigning step, for assigning both a data modulation mechanism and a data transmission rate to a base station BS and each relay station RS according to the priority to generate a multicast table. In one embodiment, the content of the multicast table is cleared before the priority arranging step. Further, the priority of the subscriber stations for service is arranged in the multicast table according to the decreasing order of the weights of the subscriber station SS.

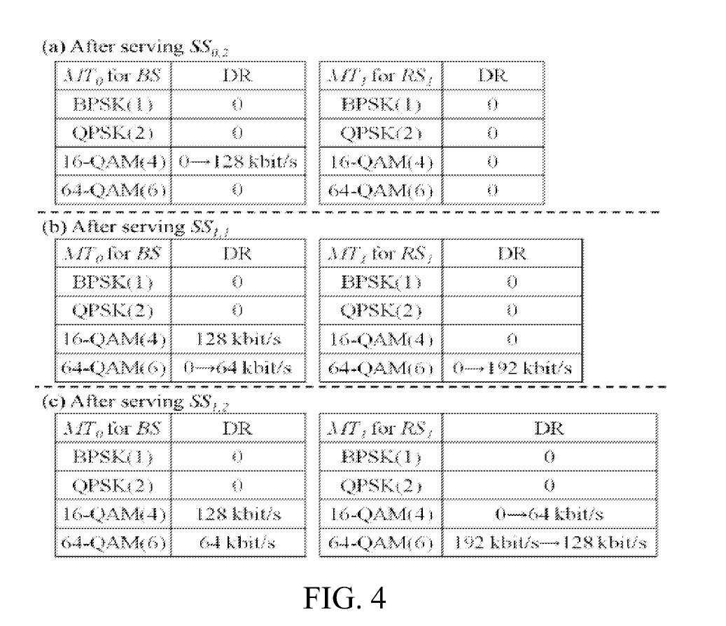

In one embodiment, referring to FIGS. 1, 3, and 4 simultaneously, assigning network weights and arranging the priority shown in FIG. 3 are an example for illustration. The data transmission rate modulation mechanism of the present invention may be selectively implemented by four types of modulation mechanisms shown in FIG. 4. The four modulation mechanisms are binary phase shift keying (BPSK), quadrature phase shift keying (QPSK), 16 quadrature amplitude modulation (16-QAM), and 64 quadrature amplitude modulation (64-QAM). Please not that the data transmission rate modulation mechanism is not limited to these four types and may be any currently existing modulation mechanism or any modulation mechanism to be developed in the future.

As shown in FIG. 3, the weight W=4 of the subscriber station SS_{0,2} is the maximum so that the subscriber station SS_{0,2} is set the highest priority 1. At the time, in order to service the subscriber station SS_{0,2}, in the multicast table, the field of the data transmission rate DR of 16-QAM(4) is set to 128 kbit/s. The reason of such setting is because the data transmission rate provided by the data modulation mechanism should be larger than or equal to the first channel quality and the second channel quality for correctly performing data transmission. For example, the data transmission rate required by the subscriber station SS_{0,2} is 128 kbit/s and the channel quality CQ_{0,2} with the base station BS is 4. Therefore, the selection of the data transmission rate should be capable of providing channel quality more than 4. For example, 16-QAM(4) providing the highest channel quality=4, or 64-QAM(6) providing the highest channel quality=6 may be selected. However, since the bandwidth used by the 64-QAM(6) for each data transmission is larger than that of 16-QAM(4), 16-QAM(4) is selected for reducing bandwidth.

The subscriber station SS_{1,1} whose weight equals 3 has the second priority. The channel quality CQ_{1,1} and CQ₁ of the subscriber station SS_{1,1} both equal to 6 and the required data transmission rate is 192 kbit/s. Since the channel quality between the relay station RS₁ and the base station BS may receive and demodulate 128 kbit/s transmitted by 16-QAM(4) that is used by the base station BS to service SS_{0,2}. Thus, for the subscriber station SS_{1,1}, the field of the data transmission rate DR of 64-QAM(6) of the base station BS in the multicast table needs to be set to 64 kbit/s and the field of the data transmission rate DR of 64-QAM(6) of the relay station RS₁ in the multicast table is set to 192 kbit/s.

Then, the subscriber station SS_{1,2} whose weight equals 2.4 has the third priority. The channel quality equals to CQ_{1,2}=4 and CQ₁=6 and the required data transmission rate is 64 kbit/s. Since the channel quality between the subscriber station SS_{1,2} and the relay station RS₁ is QO_{1,2}=4, for the subscriber station SS_{1,2}, the field of the data transmission rate DR of 16-QAM(4) of the relay station RS₁ in the multicast table can be set to 64 kbit/s. By such a method, the data transmission rate DR of 64-QAM(6) of the relay station RS₁ in the multicast table can be subtracted with the unnecessary portion, where change from 192 kbit/s to 128 kbit/s to reduce the usage of the bandwidth. It is because the channel quality between the subscriber station SS_{1,1} and the relay station RS₁ can receive and demodulate data transmission rate 64 kbit/s with 16-QAM(4). A plurality of multicast tables are generated by repeating the above standard of the parameter assigning step of Step S108 until the bandwidth in the network is completely consumed or all the subscriber stations are serviced.

Step S110: a broadcast executing step, executing network video multicast according to the multicast table

Step S112: end.

It should be noted that the video multicast system and method are applicable to WiMAX relay networks but not limited to the above example. They are also applicable to any existing relay network or any relay network to be developed in the future. Further the above mentioned relay station may selectively use the data modulation mechanisms to allocate bandwidth for a subscriber station based on the data transmission rate required by the subscriber station

The scalable video multicast system and method in WiMAX networks determine how much network productivity a subscriber station can acquire for service in a bandwidth unit and then assign a weight to each subscriber station. Servicing the subscriber station is performed sequentially based on the weights of the subscriber stations until the bandwidth in the network is completely consumed or all the subscriber stations are serviced. Furthermore, the video multicast system and method can effectively use the bandwidth to change the previous arranged setting based on the new condition to reduce the unnecessary bandwidth for data transmission rates. Therefore, the problems in the prior art can be solved and the purpose of effectively servicing more users within a limited bandwidth is achieved.

Although the present invention has been fully described by the above embodiments, the embodiments should not constitute the limitation of the scope of the invention. Various modifications or changes can be made by those who are skilled in the art without deviating from the spirit of the invention. Any embodiment or claim of the present invention does not need to reach all the disclosed objects, advantages, and uniqueness of the invention. Besides, the abstract and the title are only used for assisting the search of the patent documentation and should not be construed as any limitation on the implementation range of the invention.

What is claimed is:

1. A scalable video multicast method in WiMAX networks, where the WiMAX network includes a base station, a plurality of relay stations, and a plurality of subscriber stations, and there is a relay station between at least one of the subscriber stations and the base station, the method comprising:
detecting a state of a subscriber station and a state of the relay station coupled with the subscriber station to determine a weight of the subscriber station;
arranging the priority of the subscriber stations for service according to the weights of broadcast paths of the subscriber stations;
assigning both a data modulation mechanism and a data transmission rate to a base station and each relay station according to the priority to generate a multicast table; and
executing network video multicast according to the multicast table.

2. The method according to claim 1, wherein the step of determining a weight of the subscriber station further comprising:
detecting a data transmitting rate required by the subscriber station, first channel quality between the base station and the relay station and second channel quality between the relay station and the subscriber station;
acquiring a first ratio of the data transmitting rate of the subscriber station to the first channel quality and a second ratio of the data transmitting rate of the subscriber station to the second channel quality;
acquiring a bandwidth according to the first ratio and the second ratio; and
acquiring the weight according to the data transmitting rate of the subscriber station and the bandwidth.

3. The method according to claim 1, further comprising:
setting the base station to comprise a plurality of data modulation mechanisms; and
setting the data modulation mechanism of the base station in the multicast table to assign data transmission rate to the subscriber station , where the data transmission rate is larger than or equal to the first channel quality.

4. The method according to claim 1, further comprising:
setting the relay station to comprise a plurality of data modulation mechanisms; and
setting the data modulation mechanism of the relay station in the multicast table to assign data transmission rate to the subscriber station, where the data transmission rate is larger than or equal to the second channel quality.

5. The method according to claim 4, wherein the relay station selectively use the data modulation mechanisms to allocate bandwidth for a subscriber station based on the data transmission rate required by the subscriber station.

6. The method according to claim 3, wherein the data modulation mechanism is selected from the group consisting of the following: binary phase shift keying (BPSK), quadrature phase shift keying (QPSK), 16 quadrature amplitude modulation (16-QAM) or 64 quadrature amplitude modulation (64-QAM).

7. A scalable video multicast method in WiMAX networks, where there is a relay station between at least one of the subscriber stations and a base station in the WiMAX network, the method comprising:
acquiring a weight according to a data transmission rate of the subscriber station and channel qualities among the base station, the relay station and the subscriber station;
arranging the priority of the subscriber stations for service according to the weights of broadcast paths of the subscriber stations and assigning both a data modulation mechanism and a data transmission rate to a base station and each relay station to generate a multicast table; and
executing network video multicast according to the multicast table.

8. The method according to claim 7, further comprising:
setting the base station and the relay station to comprise a plurality of data modulation mechanisms; and
setting the data modulation mechanism of the base station and the relay station in the multicast table to assign data transmission rate to the base station and the subscriber station separately, where the data transmission rates is larger than or equal to the channel qualities.

9. The method according to claim 8, wherein the relay station selectively use the data modulation mechanisms to allocate bandwidth for a subscriber station based on the data transmission rate required by the subscriber station.

10. A scalable video multicast system in WiMAX networks, comprising:
a base station, for providing a video broadcast service;
a plurality of relay stations, providing first channel quality between the relay station and the base station, wherein each relay station is set between at least one of the subscriber stations and the base station; and
a plurality of subscriber stations, providing a data transmission rate required by the subscriber station, and second channel quality between the subscriber station and the relay station;
wherein the scalable video multicast system executes following steps:
the base station acquires a first ratio according to the ratio of the data transmitting rate of the subscriber station to the first channel quality, acquires a second ratio according to the ratio of the data transmitting rate of the subscriber station to the second channel quality, acquires a bandwidth according to the first ratio and the second ratio, and acquires a weight according to the data transmitting rate of the subscriber station and the bandwidth;
the priority of the subscriber stations is arranged for service according to the weights of broadcast paths of the subscriber stations; data modulation mechanism and data transmission rate are assigned to a base station and each relay station according to the priority to generate a multicast table; and
network video multicast is executed according to the multicast table.

11. The system according to claim 10, wherein the relay station selectively use the data modulation mechanisms to allocate bandwidth for a subscriber station based on the data transmission rate required by the subscriber station.
